(19) United States
(12) Patent Application Publication
(10) Pub. No.: US 2023/0128400 A1
(43) Pub. Date: Apr. 27, 2023

(54) MANAGEMENT DEVICE AND NON-TRANSITORY COMPUTER-READABLE STORAGE MEDIUM STORING PROGRAM

(71) Applicant: SEIKO EPSON CORPORATION, TOKYO (JP)

(72) Inventor: Keisuke HAMANO, Matsumoto-Shi (JP)

(21) Appl. No.: 18/049,888

(22) Filed: Oct. 26, 2022

(30) Foreign Application Priority Data
Oct. 27, 2021 (JP) 2021-175221

(51) Int. Cl. H04L 41/0213

(52) U.S. Cl. CPC H04L 41/0213

(57) ABSTRACT

A second management device coupled to a device includes: a local communication IF communicating with the device; a second storage storing a device list in which the device that the local communication IF can communicate with is registered; and a second device management unit acquiring device information from the device registered in the device list. The second device management unit generates the device list and causes the second storage to store the device list, when the second management device shifts from a first state to a second state.

The present application is based on, and claims priority from JP Application Serial Number 2021-175221, filed Oct. 27, 2021, the disclosure of which is hereby incorporated by reference herein in its entirety.

### BACKGROUND

### 1. Technical Field

The present disclosure relates to a management device and a non-transitory computer-readable storage medium storing a program.

### 2. Related Art

According to the related art, a system for managing a device coupled to a computer is known. For example, JP-A-2005-128890 discloses a system for managing a printer locally coupled to a computer, and a network printer. In this system, the computer acquires printer information from the locally coupled printer, executes communication with the network printer, and thus acquires printer information.

In the system for managing a device, when the configuration such as the number or type of devices coupled to the computer is changed, the computer needs to update information about a device to be managed, in response to the change in the configuration. However, if the configuration of the device is changed when the operation state of the computer is changed, a misalignment between the information held by the computer and the actual configuration may occur. For example, if a device is coupled to the computer when the computer is in a power-saving state, the computer may not recognize the coupled device.

### SUMMARY

An aspect of the present disclosure is directed to a management device coupled to a device, the management device including: a device communication unit communicating with the device; a storage unit storing a device list in which the device that the device communication unit can communicate with is registered; and a device control unit acquiring device information from the device registered in the device list. The device control unit generates the device list and causes the storage unit to store the device list, when the management device shifts from a first state to a second state.

Another aspect of the present disclosure is directed to a non-transitory computer-readable storage medium storing a program. The program is executable by a computer communicatively coupled to a device. The program causes the computer to execute:

acquiring, based on a device list stored in a storage unit and in which the device that can communicate with the computer is registered, device information from the device registered in the device list; and generating the device list and causing the storage unit to store the device list, when the computer shifts from a first state to a second state.

### BRIEF DESCRIPTION OF THE DRAWINGS

FIG. 1 shows the configuration of a management system.

FIG. 2 is a schematic view showing an example of the data structure of a device list.

FIG. 3 is a sequence chart showing an operation of the management system.

FIG. 4 is a flowchart showing an operation of a second management device.

### DESCRIPTION OF EXEMPLARY EMBODIMENTS

An embodiment of the present disclosure will now be described with reference to the drawings. Each drawing is simply an illustrative example for explaining the embodiment.

### 1. Configuration of Management System

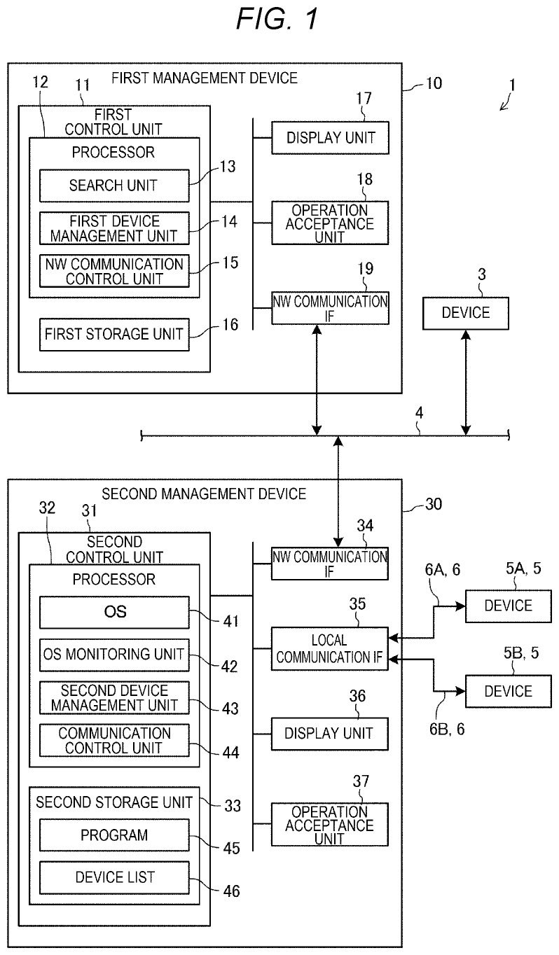

FIG. 1 shows the configuration of a management system 1 according to this embodiment.

The management system 1 includes a first management device 10 and a second management device 30. The first management device 10 is implemented by a PC (personal computer), a server computer, a tablet computer, or an information processing device having a processing capability equivalent to the processing capability of these computers. The second management device 30 is implemented by a device similar to the first management device 10. Hardware that can implement a first control unit 11 in the embodiment may be referred to as the first management device. Hardware that can implement a second control unit 31 in the embodiment may be referred to as the second management device.

The first management device 10 and the second management device 30 are each connected to a network 4. The network 4 is a communication network that enables execution of data communication between devices. The network 4 may be, for example, a local network such as a LAN (local area network) , or a wide area network. The network 4 may also be, for example, an open network such as the internet. The network 4 may be configured to include a communication line such as a dedicated line, a public line network or a cellular communication line, and a communication device such as a router or a gateway device.

The management system 1 manages a device 3 and a device 5. The device 3 is a network device connected to the network 4. The device 5 is locally connected to the second management device 30 via a local communication channel 6. The local communication channel 6 is, for example, a USB cable conforming to a USB (Universal Serial Bus) communication standard. The local communication channel 6 may be any communication channel that can connect a computer functioning as the second management device 30 and the device 5. The local communication channel 6 may be other communication cables than the USB cable and may be a wireless communication channel configured by Wi-Fi or Bluetooth. Wi-Fi is a registered trademark. Bluetooth is a registered trademark.

The second management device 30 is equivalent to an example of a management device. As viewed from the second management device 30, the first management device 10 is equivalent to an example of an external management device.

The devices 3, 5 are devices to be managed by the management system 1 and may be, for example, a printer or a scanner. The devices 3, 5 may be a multifunction device or the like having a plurality of functions such as a printer and a scanner. The device 3 and the device 5 may be devices of the same type or may be devices of different types.

The device 5 is referred to as a locally connected device because the device 5 is connected to the second management device 30 via the local communication channel 6. If the device 5 is connected to the network 4 like the device 3, the device 5 functions as a network device similarly to the device 3. The number of devices 3 and the number of devices 5 to be managed by the management system 1 are not limited. The configuration shown in FIG. 1 is an example. Similarly, the number of second management devices 30 recognized by the first management device 10 is not limited to one. In order to distinguish the locally connected device and the network device, the locally connected device may be referred to as a first device and the network device may be referred to as a second device.

The first management device 10 has the first control unit 11, a display unit 17, an operation acceptance unit 18, and a NW communication IF (interface) 19. The first control unit 11 has a processor 12 and a first storage unit 16. The processor 12 is an information processing unit formed of a CPU (central processing unit), an MPU (micro-processing unit), or the like. The processor 12 executes a control program stored in the first storage unit 16 and thus controls each part of the first management device 10. The first storage unit 16 is a non-volatile storage device having a magnetic storage medium or a semiconductor memory element. The first storage unit 16 stores a program executed by the processor 12 and data processed by the processor 12. The first control unit 11 may have a volatile storage device in addition to the first storage unit 16. The volatile storage device may form a work area for the processor 12.

The display unit 17 is formed of a liquid crystal display or the like. The display unit 17 displays a character or an image under the control of the first control unit 11. The operation acceptance unit 18 is coupled to one or a plurality of input devices and accepts an operation from the input device(s). The operation acceptance unit 18 notifies the first control unit 11 of the content of the accepted operation. The input device is, for example, a keyboard, a mouse, or a touch panel.

The NW communication IF 19 is connected to the network 4 and executes communication with the device 3 and the second management device 30 via the network 4. The NW communication IF 19 is, for example, a communication device having a connector to which a LAN cable can be coupled, and a LAN interface circuit. The NW communication IF 19 may be a wireless communication device wirelessly connected to the network 4. The NW communication IF 19 executes communication in conformity with a predetermined communication standard. The predetermined communication standard may be, for example, TCP/IP (Transmission Control Protocol/Internet Protocol) or UDP (User Datagram Protocol).

The second management device 30 has the second control unit 31, a NW communication IF 34, a local communication IF 35, a display unit 36, and an operation acceptance unit 37.

The second control unit 31 has a processor 32 and a second storage unit 33. The processor 32 is an information processing unit formed of a CPU, an MPU, or the like. The processor 32 executes a control program stored in the second storage unit 33 and thus controls each part of the second management device 30. The second storage unit 33 is a non-volatile storage device having a magnetic storage medium or a semiconductor memory element. The second storage unit 33 stores a program executed by the processor 32 and data processed by the processor 32. The second control unit 31 may have a volatile storage device in addition to the second storage unit 33. The volatile storage device may form a work area for the processor 32.

The NW communication IF 34 is connected to the network 4 and executes communication with the first management device 10 via the network 4. The NW communication IF 34 is, for example, a communication device having a connector to which a LAN cable can be coupled, and a LAN interface circuit. The NW communication IF 34 may be a wireless communication device wirelessly connected to the network 4. The NW communication IF 34 executes communication in conformity with a predetermined communication standard. The predetermined communication standard may be, for example, TCP/IP or UDP. The NW communication IF 34 is equivalent to an example of a network communication unit.

The local communication IF 35 is an interface for locally connecting one or more devices to the second management device 30 via the local communication channel 6. The local communication IF 35 is, for example, an interface device wiring a device and has a connector to which a cable can be coupled and an interface circuit transmitting and receiving a signal via the cable. In an example, the local communication IF 35 in the embodiment is a USB interface device to which a USB cable can be coupled. The local communication channel 6 may be a wireless communication channel. That is, the local communication IF 35 may be a wireless communication device executing wireless communication with a device. The local communication IF 35 is equivalent to an example of a device communication unit.

A plurality of local communication channels 6 can be connected to the local communication IF 35 in the embodiment. The second control unit 31 identifies each of the plurality of local communication channels 6 connected to the local communication IF 35, based on connection identification information. The connection identification information is identification information provided for the local communication channels 6 by the second control unit 31 and is, for example, numbers allocated in order from a predetermined number (for example, 0). In this embodiment, two local communication channels 6A, 6B can be connected to the local communication IF 35. The local communication channel 6A is connected to a device 5A. The local communication channel 6B is connected to a device 5B. In the description below, when the local communication channels 6A, 6B are not distinguished from each other, these local communication channels are referred to as the local communication channel 6. The same applies to the devices 5A, 5B.

The display unit 36 is formed of a liquid crystal display or the like. The display unit 36 displays a character or an image under the control of the second control unit 31. The operation acceptance unit 37 is coupled to one or a plurality of input devices and accepts an operation from the input device(s). The operation acceptance unit 37 notifies the second control unit 31 of the content of the accepted operation. The input device is, for example, a keyboard, a mouse, or a touch panel.

The first management device 10 executes communication using a predetermined network management protocol via the network 4 and thus manages a device to be managed. The predetermined network management protocol is, for example, SNMP (Simple Network Management Protocol). The device 3 can execute communication conforming to SNMP. In this case, the first management device 10 functions as an SNMP manager, and a resident application in the device 3, which is a network device, functions as an SNMP agent.

For example, the first management device 10 transmits a processing request conforming to SNMP and the SNMP agent of the device 3 transmits information about the device 3 to the first management device 10 as a response to the processing request. The SNMP agent of the device 3 also processes information held by the device 3 according to the processing request from the first management device 10.

Also, the first management device 10 executes communication with the second management device 30 and thus manages the device 5 locally connected to the second management device 30. The first management device 10 stores information about the management of the device 5 in the first storage unit 16 in order to execute the management of the device 5.

The first storage unit 16 stores, for example, communication information for the management system 1 to communicate with the second management device 30 and management information about the device 5 connected to the second management device 30. The communication information is, for example, the network address of the second management device 30 in the network 4. The management information includes information specifying the device 5 connected to the second management device 30. For example, the management information includes the serial number of the device 5. The serial number of the device 5 is information provided for each device 5 by a business operator producing or selling the device 5. The serial number may be a character string made up of a number and may include a symbol. The serial number may include a character string corresponding to a code representing the business operator producing or selling the device 5, the model name, the type of the device, or the like. The management information also includes operation information about the operation state of the device 5.

The processor 12 has a search unit 13, a first device management unit 14, and a NW communication control unit 15 as functional units for implementing the management of the network 4 and the device 5. These functional units are implemented by the processor 12 executing a program and thus by the cooperation between hardware and software.

The search unit 13 executes communication with the second management device 30 via the network 4 and searches for the device 5 connected to the second management device 30. The search unit 13 determines whether the first management device 10 is in a state of being able to communicate with the second management device 30 via the network 4 or not, based on the communication information stored in the first storage unit 16. The search unit 13 designates the local communication channel 6 of the second management device 30 and makes an inquiry to the second management device 30 about the connection state of the device 5. For example, the search unit 13 designates the local communication channel 6A and requests a response about whether the device 5 is connected to the local communication channel 6A or not, from the second management device 30. Next, the search unit 13 requests a response about whether the device 5 is connected to the local communication channel 6B or not, from the second management device 30. The search unit 13 updates the management information stored in the first storage unit 16, based on the response from the second management device 30.

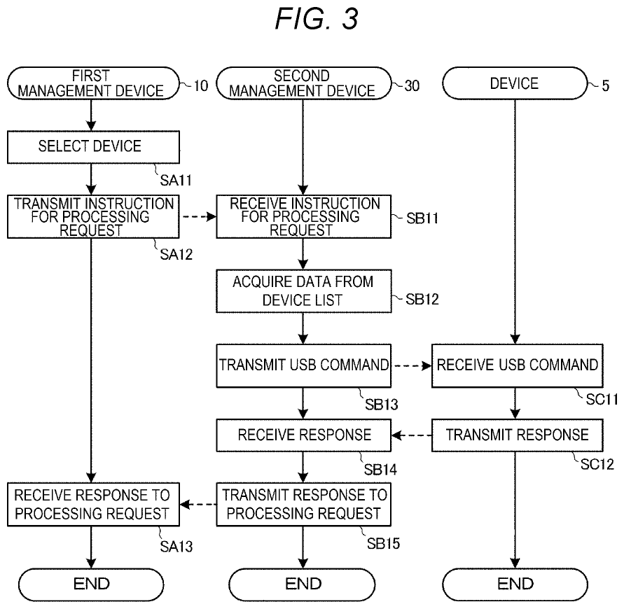

The first device management unit 14 executes communication with the second management device 30, based on the management information stored in the first storage unit 16, and thus manages the device 5. The first device management unit 14 transmits, for example, a processing request conforming to SNMP to the second management device 30. The second management device 30 operates as an SNMP agent. The second management device 30 acquires information from the device 5 in response to the processing request from the first management device 10 and transmits the acquired information to the first management device 10. The first device management unit 14 updates the management information stored in the first storage unit 16, based on the acquired information. The operation relating to the management of the device 5 will be described in detail with reference to FIG. 3.

The NW communication control unit 15 causes the NW communication IF 19 to operate under the control of the search unit 13 and the first device management unit 14. The NW communication control unit 15 causes the NW communication IF 19 to execute communication with the device 3 and communication with the second management device 30.

The second management device 30 stores a program 45 and a device list 46 in the second storage unit 33 in order to execute the management of the device 5. The second storage unit 33 is equivalent to an example of a storage unit.

The processor 32 has an OS (operating system) 41, an OS monitoring unit 42, a second device management unit 43, and a communication control unit 44. The processor 32 executes basic software of the computer forming the second management device 30 and thus configures the OS 41. The OS 41 implements a basic function of the second management device 30 and provides a platform for an application program.

For example, the OS 41 causes the second management device 30 to operate in one of a first state and a second state. The second state is a state where each unit provided in the second management device 30 operates at a rated capacity. The second state can be said to be a normal operation state. The first state is a state where the power consumed by the second management device 30 is lower than in the second state. The first state can be said to be a power-saving state. The first state can also be referred to as sleep, standby, suspend, hibernate or the like. The second management device 30 switches between and executes the first state and the second state.

In the first state, the second management device 30 causes at least one of the processor 32, the NW communication IF 34, the local communication IF 35, the display unit 36, and the operation acceptance unit 37 to operate in the power-saving state, where the power consumption is low. For example, in the first state, the processor 32 operates at a lower clock frequency than in the second state. Also, for example, in the first state, the NW communication IF 34 executes processing of detecting a received signal at a longer cycle than in the second state. Also, for example, in the first state, the local communication IF 35 executes processing of detecting a received signal from the local communication channel 6 at a longer cycle than in the second state. In the first state, the local communication IF 35 may stop the processing of detecting a received signal from the local communication channel 6. Also, for example, in the first state, the display unit 36 turns off the backlight, makes the luminance of the backlight lower than in the second state, or stops displaying. Also, for example, in the first state, the operation acceptance unit 37 executes processing of detecting an operation to the input device at a longer cycle than in the second state.

The OS 41 controls the switching between the first state and the second state. For example, when a condition for shifting to the first state is satisfied while the second management device 30 is operating in the second state, the OS 41 executes a power-saving shift sequence in which each unit in the second management device 30 is shifted to the first state. The power-saving shift sequence is a sequence in which the second management device 30 shifts from the second state to the first state. In the power-saving shift sequence, the OS 41 changes an operation condition of at least one of the processor 32, the NW communication IF 34, the local communication IF 35, the display unit 36, and the operation acceptance unit 37 to an operation condition corresponding to the first state. The operation condition includes, for example, one of the clock frequency of the processor 32, the detection cycle of the NW communication IF 34, the detection cycle of the local communication IF 35, the luminance or on/off of the backlight of the display unit 36, and the detection cycle of the operation acceptance unit 37.

The condition for shifting from the second state to the first state may be, for example, that a state where the NW communication IF 34 does not detect a received signal continues for a predetermined period of time or longer, or that a state where the local communication IF 35 does not detect a received signal continues for a predetermined period of time or longer. The condition may also be that a state where the operation acceptance unit 37 does not detect an input continues for a predetermined period of time or longer. The condition may also be that an instruction to shift to the power-saving state is given by an operation at the operation acceptance unit 37.

The first state may also include a plurality of operation states. That is, the second management device 30 may be able to execute a plurality of operation states where the power consumption is lower than in the second state. In this case, the plurality of operation states where the power consumption is lower than in the second state are collectively referred to as the power-saving state.

When a condition for shifting to the second state is satisfied while the second management device 30 is in the first state, for example, the OS 41 executes a return sequence in which each unit in the second management device 30 is shifted to the second state. In the return sequence, the OS 41 changes the operation condition of at least one of the processor 32, the NW communication IF 34, the local communication IF 35, the display unit 36, and the operation acceptance unit 37 to an operation condition corresponding to the second state. The condition for shifting from the first state to the second state may be, for example, that an instruction to shift to the normal operation state is given by an operation at the operation acceptance unit 37. The condition may also be that the NW communication IF 34 receives a signal giving an instruction to shift to the normal operation state.

The OS monitoring unit 42, the second device management unit 43, and the communication control unit 44 are functional units relating to the management of the device 5. These functional units are implemented by the processor 32 executing the program 45 stored in the second storage unit 33 and thus by the cooperation between hardware and software. The program 45 is software for managing the device 5 and is, for example, an application program installed in the second management device 30.

The OS monitoring unit 42 monitors the switching between the first state and the second state by the OS 41. Specifically, the OS monitoring unit 42 detects that the OS 41 executes the power-saving shift sequence and that the OS 41 executes the return sequence.

The second device management unit 43 manages the device 5. The second device management unit 43 executes communication with the device 5 connected to the local communication IF 35, in response to a request transmitted from the first management device 10. The second device management unit 43 refers to the device list 46 stored in the second storage unit 33. The device list 46 is a list including information about the device 5 connected to the local communication IF 35. The second device management unit 43 is equivalent to an example of a device control unit.

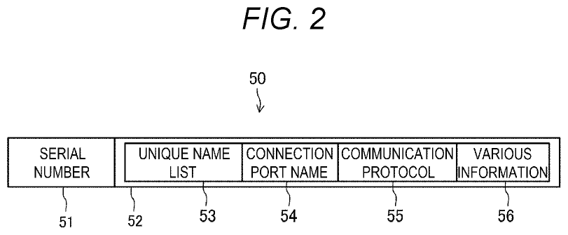

FIG. 2 is a schematic view showing an example of the data structure of the device list 46 and shows an example of the configuration of device data 50 forming the device list 46.

The device list 46 includes one device data 50 for one device 5. The device data 50 includes a serial number 51 and a data part 52. The serial number 51 is the serial number 51 of the device 5. The serial number 51 is a key of the device data 50. The data part 52 is a value corresponding to the serial number 51.

The data part 52 includes a unique name list 53, a connection port name 54, a communication protocol 55, and various information 56. The unique name list 53 includes a unique name provided for the device 5. The unique name is, for example, a device name provided by the second management device 30 in order to identify the device 5. The unique name list 53 can include a plurality of unique names provided for one device 5.

The connection port name 54 is information for the second management device 30 to identify the port to which the device 5 is connected in the local communication IF 35. In this embodiment, one local communication channel 6 is connected to one port in the local communication IF 35. Therefore, the connection port name 54 in this embodiment is connection identification information of the local communication channel 6 to which the device 5 is connected. The connection port name 54 may be identification information provided for the connection port in the local communication IF 35. The connection port name 54 may also be other information for the second management device 30 to identify the connection port in the local communication IF 35. For example, the connection port name 54 is not limited to information about the physical port in the local communication IF 35 and may also be information about a logical port.

The communication protocol 55 is information designating a communication protocol that can be used in the communication with the device 5. The various information 56 can include various information about the device 5.

The device list 46 can include the device data 50 shown in FIG. 2 corresponding to the number of devices 5. The processor 32 refers to the device list 46 and thus can specify one device 5 from among a plurality of devices 5 connected to the local communication IF 35. Thus, the processor 32 can execute communication with the specified device 5.

The communication control unit 44, under the control of the second device management unit 43, controls the NW communication IF 34 to execute communication with the first management device 10. The communication control unit 44, under the control of the second device management unit 43, also controls the local communication IF 35 to execute communication with the device 5.

### 2. Device Management by Management System

FIG. 3 is a sequence chart showing an operation of the management system 1 and shows an example of an operation relating to the management of the device 5. In FIG. 3, steps SA11 to SA13 are operations of the first management device 10 and, specifically, are executed by the first control unit 11. Steps SB11 to SB15 are operations of the second management device 30 and are executed by the second control unit 31. Steps SC11 and SC12 are operations of the device 5.

In step SA11, the first device management unit 14 selects a device 5 to be a processing target, based on the management information stored in the first storage unit 16. In step SA12, the first device management unit 14 transmits an instruction to the second management device 30 via the NW communication IF 19. The instruction transmitted in step SA12 is an instruction requesting that the second management device 30 causes the device 5 to execute processing. The requested processing is not limited and may be, for example, processing of transmitting information about the operation state of the device 5, processing of changing a setting about the operation of the device 5, or the like.

In this embodiment, the first management device 10 requests the device 5 to transmit the information about the operation state. The information about the operation state may be, for example, status information representing the state of occurrence of an error in the device and the active state of the device. When the device 5 is a printer, the information about the operation state may include the amount of remaining consumables such as ink and print medium, the count value of a print counter, and the like.

In step SB11, the second device management unit 43 receives the instruction transmitted from the first management device 10. In step SB12, the second device management unit 43 refers to the device list 46 stored in the second storage unit 33 and acquires the device data 50 corresponding to the serial number designated by the instruction received in step SB11.

In step SB13, the second device management unit 43 refers to the device data 50 and thus specifies the local communication channel 6 to which the device 5 is connected and the communication protocol executable by the device 5. The second device management unit 43 generates a USB command instructing the device 5 to execute processing.

For example, in step SA12, the first device management unit 14 generates an SNMP packet requesting the device 5 to transmit device information. This SNMP packet includes the serial number of the device 5 as the device identification information identifying the device 5. The SNMP packet also includes information designating the transmission of device information as the processing to be executed by the device 5. The SNMP packet may include information designating a type of device information to be transmitted by the device 5. The SNMP packet includes the network address of the second management device 30 as information about the destination of the SNMP packet.

In step SB11, the second device management unit 43 receives the SNMP packet transmitted from the first management device 10. In step SB12, the second device management unit 43 refers to the device list 46, based on the serial number of the device 5 included in the SNMP packet, and thus acquires the device data 50. In step SB13, the second device management unit 43 adds a USB header to the SNMP packet and thus generates a USB command. The USB header is a header that can be interpreted by a USB device locally connected to the second management device 30. The USB command generated by the second device management unit 43 has the USB header added thereto and therefore is handled by the USB device as a type of command conforming to the USB communication standard. In step SB13, the second device management unit 43 transmits the generated USB command to the device 5 via the local communication channel 6.

In step SC11, the device 5 receives the USB command transmitted from the second management device 30. The device 5 interprets the received USB command and generates device information according to the instruction included in the USB command. In step SC12, the device 5 transmits a response including the device information to the second management device 30. The format of the response transmitted from the device 5 in step SC12 is, for example, a command response format including a USB header.

In step SB14, the second device management unit 43 receives the response transmitted from the device 5. In step SB15, the second device management unit 43 analyzes the response received from the device 5 and thus generates a response to the processing request. At this point, the second device management unit 43 generates, for example, an SNMP packet including the value of the command response received from the device 5, as the response to the processing request. This SNMP packet includes the network address of the first management device 10 as the destination. The second device management unit 43 transmits the response to the processing request, to the first management device 10.

In step SA13, the first device management unit 14 receives the response to the processing request, transmitted from the second management device 30. The first device management unit 14 updates the management information stored in the first storage unit 16, based on the device information included in the received response.

As shown in FIG. 3, in the management system 1, the first management device 10 can manage the operation state of the device 5 locally connected to the second management device 30. In the operations shown in FIG. 3, the first management device 10 transmits an instruction and the device 5 transmits a response including device information in response to the instruction. In this process, the second management device 30 mediates the communication between the first management device 10 and the device 5. Therefore, in the management system 1, the first management device 10 can be referred to as a device management device and the second management device 30 can be referred to as an intermediate management device.

### 3. Operation of Second Management Device

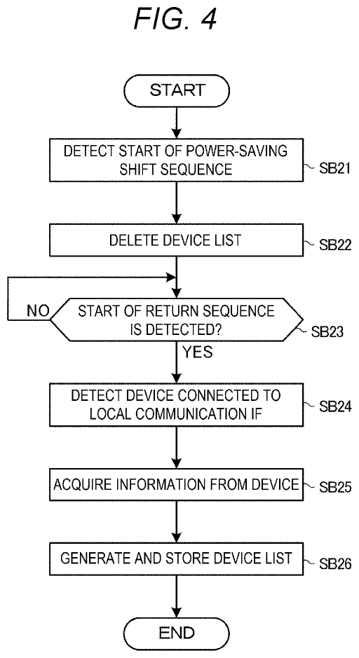

FIG. 4 is a flowchart showing an operation of the second management device 30. Specifically, FIG. 4 shows an operation of the second control unit 31 in the case where the operation state of the management system 1 shifts from the second state to the first state and in the case where the operation state shifts from the first state to the second state.

The operation in FIG. 4 is started when the OS monitoring unit 42 detects that the OS 41 has started the power-saving shift sequence.

In step SB21, the OS monitoring unit 42 detects the start of the power-saving shift sequence. Subsequently, in step SB22, the second device management unit 43 deletes the device list 46 stored in the second storage unit 33.

Subsequently, the OS monitoring unit 42 monitors the operation of the OS 41. In step SB23, the OS monitoring unit 42 determines whether the OS 41 has started the return sequence or not. The operation in step SB23 is executed at a predetermined cycle of time while the second management device 30 is in the first state. When it is not detected that the OS 41 has started the return sequence (NO in step SB23), the OS monitoring unit 42 waits. When it is detected that the OS 41 has started the return sequence (YES in step SB23), the second control unit 31 shifts to step SB24.

In step SB24, the second device management unit 43 detects the device 5 connected to the local communication IF 35. For example, the second device management unit 43 detects the connection port provided in the local communication IF 35. By this processing, the local communication channels 6A, 6B connected to the local communication IF 35 are detected. The second device management unit 43 determines whether the device 5 is connected or not, with respect to each of the detected local communication channels 6A, 6B. When the second device management unit 43 detects that the device 5 is connected to the local communication channels 6A, 6B, the second device management unit 43 detects the connected device 5.

Next, in step SB25, the second device management unit 43 executes communication with the detected device 5 and thus acquires information from the device 5. In step SB25, for example, the second device management unit 43 acquires each piece of information included in the device data 50 from the device 5. Specifically, the second device management unit 43 acquires the serial number of the device 5, the unique name of the device 5, the communication protocol that can be used by the device 5, and other information. When a plurality of devices 5 are connected to the local communication IF 35, the second device management unit 43 acquires information from all the devices 5 connected to the local communication IF 35, in step SB25.

In step SB26, the second device management unit 43 generates device data 50 based on the information acquired in step SB25 and generates a device list 46 formed of one or a plurality of device data 50. The second device management unit 43 causes the second storage unit 33 to store the generated device list 46 and then ends this processing.

In the second control unit 31, the OS monitoring unit 42 constantly monitors whether the OS 41 starts the power-saving shift sequence while the second management device 30 is operating in the second state. When the OS monitoring unit 42 detects that the OS 41 starts or has started the power-saving shift sequence, the second control unit 31 executes the operation shown in FIG. 4.

### 4. Effects of Embodiment

As described above, in the management system 1 described in the embodiment, the second management device 30 is a management device coupled to the device 5. The second management device 30 has the local communication IF 35 communicating with the device 5, and the second storage unit 33 storing the device list 46, in which the device 5 that the local communication IF 35 can communicate with is registered. The second management device 30 has the second device management unit 43 acquiring device information from the device 5 registered in the device list 46. The second device management unit 43 generates the device list 46 and causes the second storage unit 33 to store the device list 46, when the second management device 30 shifts from the first state to the second state.

The program 45 is a program executable by the second management device 30, which is a computer communicatively coupled to the device 5. The program 45 causes the second management device 30 to acquire device information from the device 5 registered in the device list 46, based on the device list 46 stored in the second storage unit 33 and in which the device 5 that can communicate with the computer is registered. The program 45 generates the device list 46 and causes the second storage unit 33 to store the device list 46, when the second management device 30 shifts from the first state to the second state.

According to this configuration, the device list 46 is generated when the operation state of the second management device 30 shifts from the first state to the second state. Thus, the device list 46 can be turned into a state that accurately reflects the configuration of the device 5 coupled to the second management device 30. Therefore, even if the configuration of the device 5 coupled to the second management device 30 is changed when the operation state of the second management device 30 is changed, the device list 46 based on the latest configuration of the device 5 can be used. The second management device 30 can thus properly manage the device 5.

In the above configuration, the second device management unit 43 may generate the device list 46 and cause the second storage unit 33 to store the device list 46, when the second device management unit 43 detects that the second management device 30 has started the return sequence, in which the second management device 30 shifts from the first state to the second state. In this case, the device list 46 can be generated swiftly corresponding to the change in the operation state of the second management device 30.

In the above configuration, the second device management unit 43 may delete the device list 46 stored in the second storage unit 33, when the second management device 30 shifts from the second state to the first state. In this case, deleting the device list 46 can prevent the misalignment between the device list 46 and the actual configuration of the device 5. Therefore, even when the configuration of the device 5 coupled to the second management device 30 is changed, the second management device 30 can properly manage the device 5.

In the above configuration, the first state may be the power-saving state, where the power consumed by the second management device 30 is lower than in the second state. According to this configuration, the device list 46 is generated when the second management device 30 shifts from the operation state with low power consumption to the second state. Therefore, even if the configuration of the device 5 coupled to the second management device 30 is changed when the second management device 30 is in the first state, the second management device 30 can use the device list 46 reflecting the latest configuration of the device 5 after shifting to the second state. Thus, the misalignment between the device list 46 held in the second management device 30 and the actual configuration of the device 5 can be prevented and the device 5 can be properly managed.

In the above configuration, the second management device 30 may have the NW communication IF 34 communicating with the first management device 10 via the network 4. The second device management unit 43 may acquire device information from the device 5 registered in the device list 46, based on an instruction received via the NW communication IF 34. In this case, the second management device 30 can use the device list 46 accurately reflecting the configuration of the device 5 when acquiring information from the device 5, based on the instruction received from the first management device 10. Therefore, the second management device 30 can securely execute the processing of acquiring information from the device 5. For example, an error due to a failure by the second management device 30 in communicating with the device 5 can be prevented. Thus, the first management device 10 can accurately manage the device 5.

### 5. Other Embodiments

The foregoing embodiment is one embodiment and can be modified or applied as desired.

For example, in the foregoing embodiment, a configuration example where the local communication IF 35 and the device 5 are connected to each other via the local communication channel 6 conforming to the USB standard is described. This is simply an example. For example, the device 5 may be connected via the local communication channel 6 conforming to a wired communication standard such as IEEE 1398 or various wireless communication standards. The second management device 30 may have a plurality of local communication IFs 35 performing communication in conformity with different communication standards from each other. In this case, the device 5 may be connected to each of the plurality of local communication IFs 35.

In the management system 1, the network management protocol for the first management device 10 to manage the device 3 or the device 5 to be managed is not limited to SNMP. For example, the first management device 10 and the second management device 30 may communicate with each other, using various protocols used for network monitoring.

Each component illustrated in FIG. 1 is simply an example. A piece of hardware individually corresponding to each component shown in FIG. 1 need not necessarily be installed. A single processor may be configured to execute a program to implement the functions of each component. A part of the functions implemented by software may be implemented by hardware. A part of the functions implemented by hardware may be implemented by software. Also, the specific detailed configuration of each of the other parts of each device in the management system 1 can be changed as desired.

The program 45 described in the embodiment can be configured in the form of a recording medium or a transmission medium transmitting the program. As the recording medium, a magnetic or optical recording medium or a semiconductor memory device can be used. The optical recording medium is, for example, a disk-type recording medium. The recording medium may also be a non-volatile storage device such as a RAM, a ROM or an HDD that is an internal storage device provided in a server device.

The steps of the operations shown in FIGS. 3 and 4 are provided by dividing the processing according to the main content of the processing in order to facilitate the understanding of the operation of each device forming the management system 1. The way the processing is divided into processing steps and the names of the processing steps do not limit the operations. The processing may also be divided into more steps according to the content of the processing. The processing may also be divided in such a way that one step includes more processing. The order of the steps may be changed according to need.

What is claimed is:

1. A management device coupled to a device, the management device comprising:
a device communication unit communicating with the device;
a storage storing a device list in which the device that the device communication unit can communicate with is registered; and
a device controller acquiring device information from the device registered in the device list,
the device controller generating the device list and causing the storage to store the device list, when the management device shifts from a first state to a second state.

2. The management device according to claim 1, wherein
the device controller generates the device list and causes the storage to store the device list, when it is detected that a sequence in which the management device shifts from the first state to the second state is started.

3. The management device according to claim 1, wherein
the device controller deletes the device list stored in the storage when the management device shifts from the second state to the first state.

4. The management device according to claim 1, wherein
the first state is a power-saving state where power consumed by the management device is lower than in the second state.

5. The management device according to claim 1, further comprising:
a network communication unit communicating with an external management device via a communication network, wherein
the device controller acquires the device information from a device registered in the device list, based on an instruction received via the network communication unit.

6. A non-transitory computer-readable storage medium storing a program, the program being executable by a computer communicatively coupled to a device,
the program causing the computer to execute:
acquiring, based on a device list stored in a storage and in which the device that can communicate with the computer is registered, device information from the device registered in the device list; and
generating the device list and causing the storage to store the device list, when the computer shifts from a first state to a second state.
